(19) United States
(12) Patent Application Publication
(10) Pub. No.: US 2016/0071388 A1
(43) Pub. Date: Mar. 10, 2016

(54) Method and System of Environmental Occupant Monitoring and Hazard Notification and Mitigation

(71) Applicant: Danny O. Levons, Miami, FL (US)

(72) Inventor: Danny O. Levons, Miami, FL (US)

(21) Appl. No.: 14/848,304

(22) Filed: Sep. 8, 2015

Related U.S. Application Data
(60) Provisional application No. 62/046,573, filed on Sep. 5, 2014.

(51) Int. Cl. G08B 21/02; G08B 21/18

(52) U.S. Cl. CPC G08B 21/02; G08B 21/182

(57) ABSTRACT

A method and apparatus for environmental occupant monitoring and hazard notification and mitigation monitors occupants in a spatial environment, sending notifications to third parties upon detection of hazardous conditions and executing safety protocols in using environmental control systems to mitigate the hazard. As specifically applied to a vehicle, an occupant sensor is utilized to detect a driver and passengers. If the driver leaves the passengers behind in the vehicle, the system notifies the driver. If a hazardous condition such as elevated temperature is detected in the vehicle, emergency response services are notified and the control systems of the vehicle are used to mitigate the hazard.

The current application claims a priority to the U.S. Provisional Patent application Ser. No. 62/046,573 filed on Sep. 5, 2014. The current application is filed on the next business day, which is Sep. 8, 2015, while Sep. 5, 2015 and Sep. 6, 2015 were on a weekend, and while Sep. 7, 2015 was a national holiday (Labor Day).

### FIELD OF THE INVENTION

The present invention relates generally to electronic safety systems, more particularly a system of sensors that trigger a series of safety responses within a closed environment such as a motor vehicle.

### BACKGROUND OF THE INVENTION

Each year, the news covers many stories about unfortunate events in which children and animals are left in cars. Since 1998 there have been at least 624 documented cases of heatstroke deaths inside motor vehicles. Excessive heat, cold, and even lack of oxygen can present dangerous conditions for any living creature left in a vehicle. This is why safety detection alert systems and child reminder alarm systems have been developed to notify vehicle operators when a warm body has been left in their vehicle. These warm bodies can include children, house pets, or even adults. No matter who or what the creature is, extreme environmental conditions can quickly cause harmful effects on the body.

Several issues exist with common vehicle safety detection alert systems in today's market, in which there is much room for improvement. Many systems simply send out basic auditory notifications or alarms to outside individuals or parties, but do not actuate a physical response to help create a safe environment for the body in the car. This could be a problem if the outside member is hearing impaired does not notice the alert, or simply takes action too slowly.

The present invention will provide users with a framework to establish a comprehensive safety system. The present invention will use a series of sensors and actuators in the vehicle's cabin to output various response functions. Not only will the present invention notify users that a living creature is still in their vehicle, but a third party will be notified as well. On top of this, the system will measure the various sensor inputs to make a decision that will change the physical environment into a safer state.

### BRIEF DESCRIPTION OF THE DRAWINGS

FIG. 1 is a conceptual visualization of the process of the present invention.

FIG. 2 is a stepwise flow diagram describing the general process of the present invention.

FIG. 3 is a stepwise flow diagram describing steps for initiating a hazard mitigation protocol in the general process of the present invention.

FIG. 4 a stepwise flow diagram describing general steps for the process of a vehicular embodiment of the present invention.

FIG. 5 is a stepwise flow diagram describing steps for triggering notifications and executing a vehicle safety protocol in the vehicular embodiment of the present invention.

FIG. 6 is a continuation of FIG. 5.

FIG. 7 is a schematic diagram of the preferred apparatus of the present invention.

FIG. 8 is a general overview of the logic flow in the preferred embodiment of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a framework for an interchangeable system that utilizes a series of sensors that are setup in a static or dynamic environment to execute a series of predefined workflows. The present invention is comprised of a detailed computerized system describing the logical flow and input and output commands. The preferred embodiment of the present invention may use the terms input, sense, or any interchangeable words to describe information taken in by the series of sensors in this system. The preferred embodiment of the present invention may use the terms response, output, or any interchangeable words to describe commands the system utilizes to actuate a function or task.

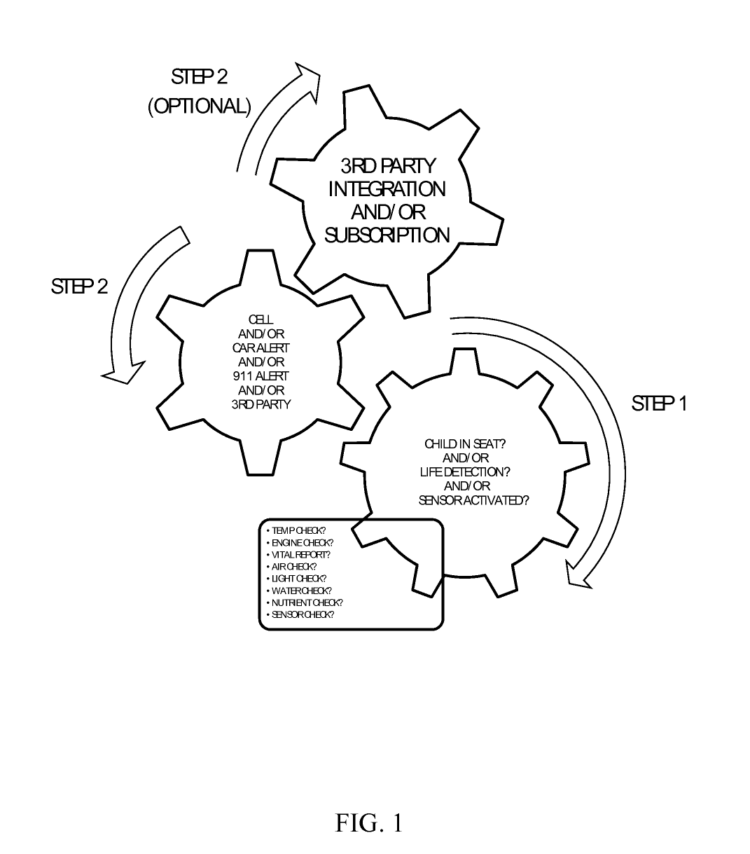

Referring to FIG. 1, the present invention is a method and system of monitoring occupants of a spatial environment, notification of hazards within the spatial environment to relevant parties, such as, but not limited to, emergency response services, and mitigation of said hazards through environmental controls. The primary focus of the present invention is an application for motor vehicles, to prevent children, pets or other occupants of the vehicle suffering heat related injuries in the event that the vehicle is left in the hot sun with the windows up. However, the general concept may be applicable in many other situations, such as, but not limited to, other vehicles such as trains or boats, offices, residences, hospitals, or other spatial environments where keeping living occupants safe is desired.

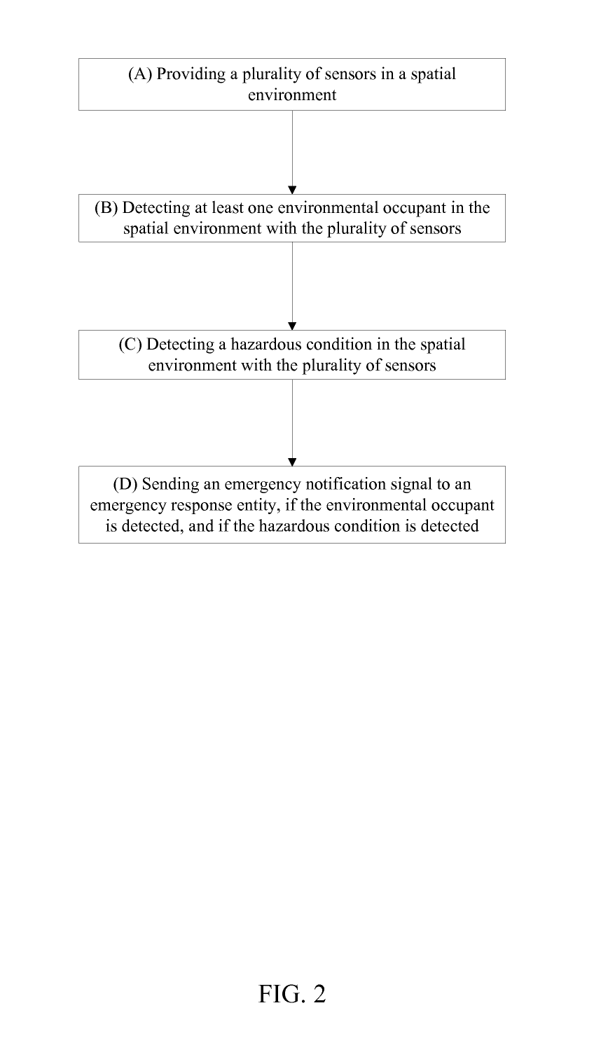

Referring to FIG. 2, in the general method of the present invention, a at least one sensor is provided in a spatial environment. The at least one sensor is not limited with respect to the type of sensor, and any relevant and useful type of sensor may be utilized in the present invention to accomplish the purpose of environmental monitoring and hazard detection, notification and mitigation. The spatial environment is also not necessarily limited to any particular environment type except where the environment type precludes the ability of the object of the present invention to be accomplished.

At least one environmental occupant is detected within the spatial environment with the at least one sensor. The environmental occupant may be, but is not limited to, a human, a dog, cat or other animal, or another type of occupant as relevant to any given specific application. The type of occupant to be detected may affect the type of sensors required. Preferably, the environmental occupant is generally detected with a temperature sensor, such as, but not limited to, an infrared sensor or a thermostat sensor, though other types of temperature sensors may be utilized, or other sensors such as motion sensors, sound sensors, or other sensors.

If the environmental occupant is detected, the system of the present invention is active. Preferably, the system of the present invention does not activate or proceed in the process unless the environmental occupant is detected, though it is contemplated that the present invention may operate continually without necessitating the environmental occupant being detected.

When the at least one sensor detect a hazardous condition in the spatial environment, an emergency notification signal is sent to an emergency response entity if the environmental occupant is detected. Alternatively, the emergency notification signal may be sent even if the environmental occupant is not detected. The hazardous condition is not necessarily limited to any particular hazardous condition, and as before may include any condition in the spatial environment which could pose a threat to the occupant. It is contemplated that a generalized algorithm may be created to recognize any hazardous condition, though it is more likely that various specific hazardous conditions will be defined with clear parameters to be ascertained through the at least one sensor in order to recognize the hazardous condition. As such, specific sensor inputs are related with specific outputs through the system of the present invention.

In the vehicular application of the present invention, the hazardous condition may correspond to an elevated temperature within the vehicle, or a lack of airflow, or another vehicle-specific hazard. Various applications of the present invention may recognize various different hazards. Other hazardous conditions contemplated include, but are not limited to, elevated concentration of toxic gases, elevated heart rate or blood pressure of the occupant or other vital signs or health indicators such as a seizure, blood analysis, nutrient levels, or any other conditions hazardous to the environmental occupant which can be detected through the at least one sensor. Sensors in the steering wheel and passenger seats may also be utilized in the present invention, in addition to other existing or future sensors, as technology develops, such as, but not limited to, heart attack sensors, diabetic condition sensors, coma sensors, seizure sensors, or any sensor which is capable of detecting a medical emergency. Sensors or other system components such as a video camera or other visual sensor and facial recognition software in order to detect various conditions, such as eye blinking or rapid eye movement in order to detect seizures or other conditions in the occupants of the vehicle.

Additionally, in the preferred embodiment of the present invention, each of the at least one sensor are continually recording sensor readings for the spatial environment, even when an occupant is not detected within the spatial environment. For example, in the vehicular embodiment, a temperature sensor is constantly measuring the temperature within the cabin of the vehicle, even when a passenger is not in the vehicle, and ideally even when the vehicle's engine and/or other system are not running. An environmental report can be generated from the data gathered by the sensors, which can be displayed to the user by any applicable means. For example, the report may be sent to an email address or mobile device associated with the user to be viewed on any computing device with a digital display, or the report may be displayed on a digital display integrated within the vehicle. The report preferably comprises a graph displaying the value of the sensor readings over time, and can be completely customizable in regards to variables such as, but not limited to, time period, comparing certain variables to each other, scale, and other variables. Data gathered by the at least one sensor is stored on a digital storage media such as, but not limited to, a flash memory drive or a solid state drive, or data may be continually transmitted to a remote server using any applicable means.

When bodies are detected, how the responses are triggered, otherwise the sensors are always sensing and recording temperature and other sensor data but only triggers alerts when bodies are detected.

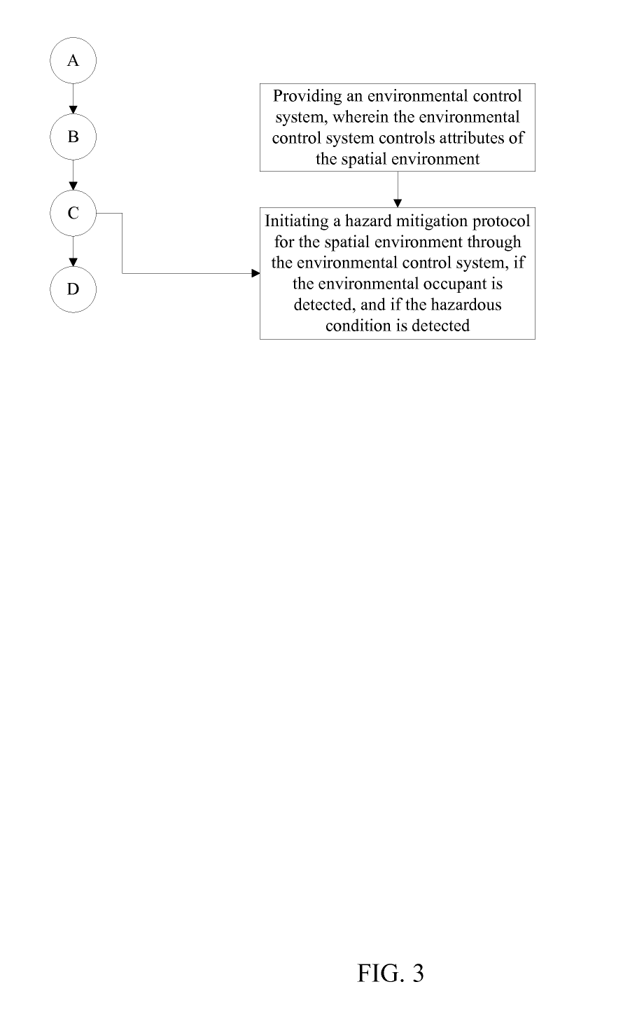

Referring to FIG. 3, the system of the preferred embodiment of the present invention additionally utilizes an environmental control system. The environmental control system is any system that is capable of manipulating and controlling various attributes, arrangements and aspects of the spatial environment. This may include, but is not limited to, heating, ventilation, and air conditioning systems, window, door or lighting controls, or other control systems. In the preferred embodiment of the present invention, a hazard mitigation protocol is initiated through the environmental control system if the environmental occupant is detected and if the hazardous condition is detected.

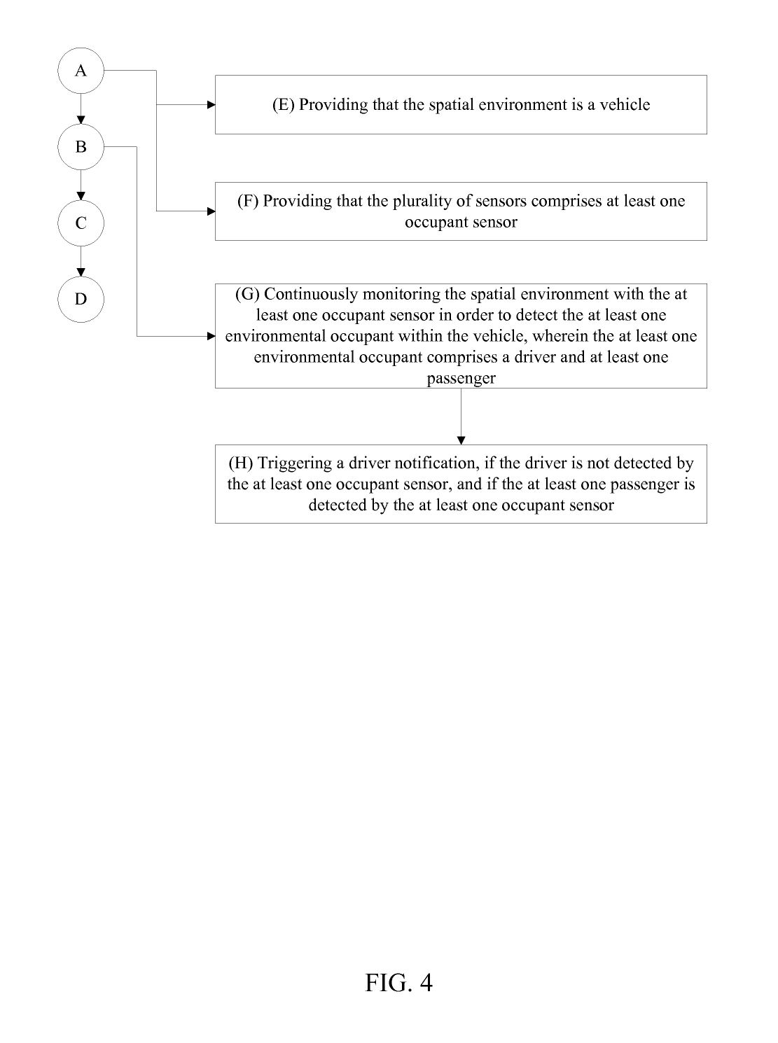

Referring to FIG. 4, one specific application the present invention will focus on is where the spatial environment is a vehicle; more specifically, an automobile. In this embodiment, the at least one sensor comprises at least one occupant sensor. Many different types of sensors may serve the purpose of detecting an occupant in a vehicle, such as, but not limited to, temperature sensors, motion sensors, and pressure sensors in the seats of the vehicle. In the preferred embodiment, the system is activated when the driver puts the vehicle in a parking gear or neutral gear.

The vehicular spatial environment is continually monitored with the at least one occupant sensor in order to detect the at least one environmental occupant within the vehicle. In this context, the at least one environmental occupant comprises a driver and at least one passenger. Generally, if the driver is not detected by the at least one occupant sensor, and if the at least one passenger (hereinafter referred to as the passenger) is detected by the at least one occupant sensor, a driver notification is triggered. In the preferred embodiment, the driver takes the form of sending an electronic message such as a text message or email to a mobile device associated with the driver. Other notifications and alarms may also be triggered, such as, but not limited to, activating the vehicle's horn, flashing the vehicle's lights, or other actions which may serve to alert the driver or a bystander.

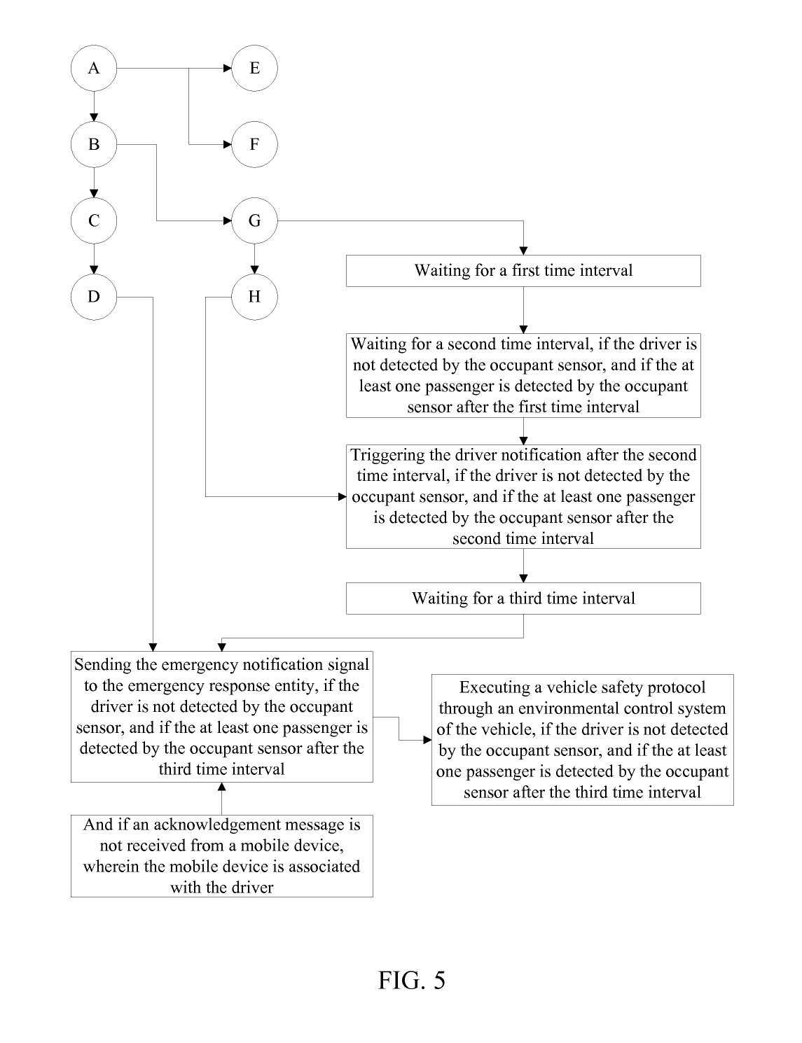

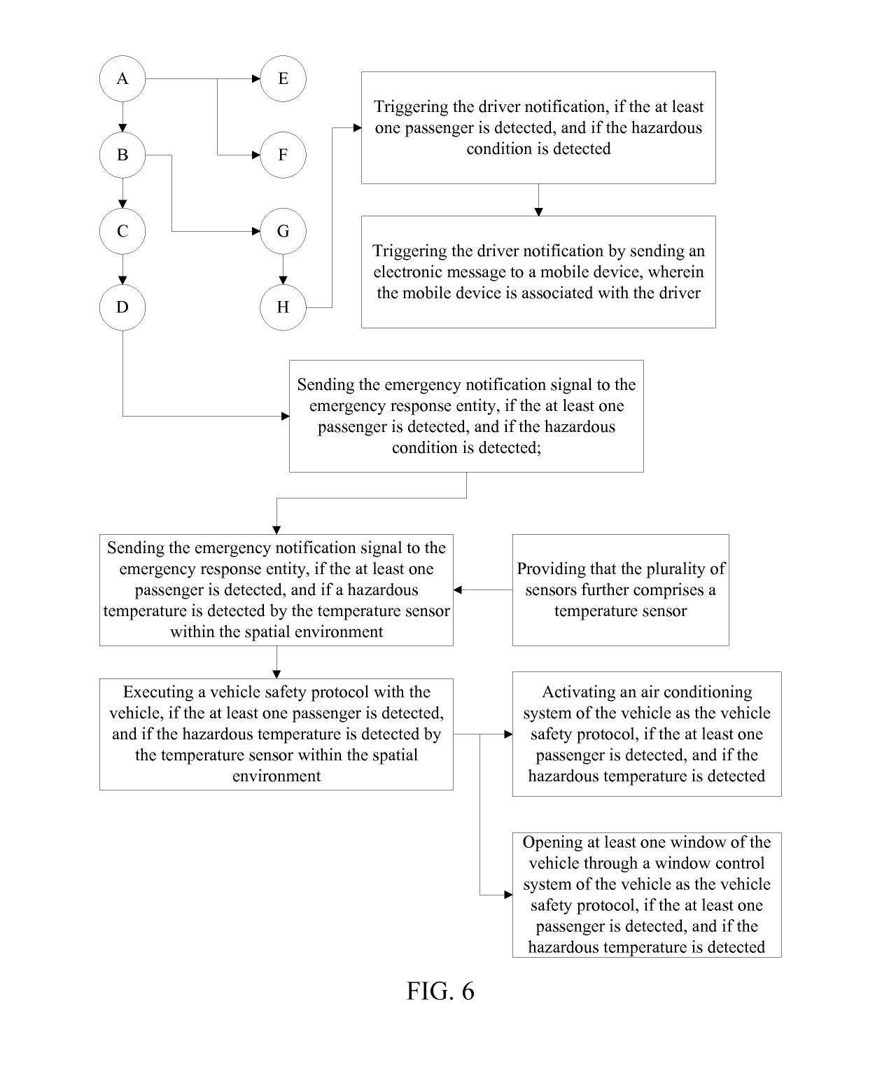

Referring to FIGS. 5, 6 and 8, the preferred embodiment of the present invention utilizes a specific logic flow for mitigating any ill effects of the driver leaving the passenger behind. The system waits for a first time interval, scanning for the driver and the passenger. If all occupants (driver and passenger) are not detected after the first time interval, the vehicle deactivates if the vehicle was previously activated, and the process ends. If the driver is not detected by the occupant sensor after the first time interval, and the passenger is detected by the occupant sensor after the first time interval, the system waits for a second time interval. If the driver is still not detected while the passenger is detected after the second time interval, the driver notification is triggered. The system then waits for a third time interval.

If the driver is still not detected while the passenger is detected after the third time interval, the emergency notification signal is sent to the emergency response entity. In one embodiment, the driver has the ability to acknowledge the driver notification by sending an acknowledgement message from the mobile device, preventing the emergency notification signal from being sent. Otherwise, a vehicle safety protocol is additionally executed through an environmental control system of the vehicle. In one embodiment, an air conditioning system of the vehicle is the environmental control system of the vehicle. In another embodiment, a window control system of the vehicle is the environmental control system. The air conditioning system and the window control system may also be operated simultaneously. Other appropriate control systems and actions may be utilized and executed according to the hazard mitigation protocol, which must be defined in accordance with the specific application of the present invention.

More generally, in the preferred embodiment the driver notification is triggered and the emergency notification signal is sent to the emergency response entity if the passenger is detected and the hazardous condition is detected. This may be specified to happen if the driver is detected or not.

For the specific case of high temperature within the vehicle, the at least one sensor further comprises a temperature sensor. The emergency notification signal is sent to the emergency response entity if the passenger is detected and if a hazardous temperature is detected by the temperature sensor within the spatial environment, wherein the hazardous temperature is specified by the operator of the system or according to a preset value known to be dangerous to adults, children, or pets. The vehicle safety protocol is also executed if the passenger is detected and if the hazardous condition is detected by the temperature sensor. In this case, the vehicle safety protocol may involve activating the air conditioning system of the vehicle, opening at least one window of the vehicle through the window control system of the vehicle, or both. Additional vehicle safety protocols may also be defined and executed as deemed necessary or desirable. In the preferred embodiment of the present invention, threshold setting for detecting various hazardous conditions are provided by default, however the user of the present invention is also capable of adjusting the threshold settings in order to customize for their particular needs.

In addition, one option which can be enabled is that hazardous or extreme conditions may be reported to the driver and/or emergency services regardless of whether or not there are any occupants within the vehicle. The at least one sensor of the present invention should be active and recording data at all times. The system of the present invention may additionally or optionally be configured to only send notifications to the user and/or emergency services when detection of occupants within the vehicle is enabled.

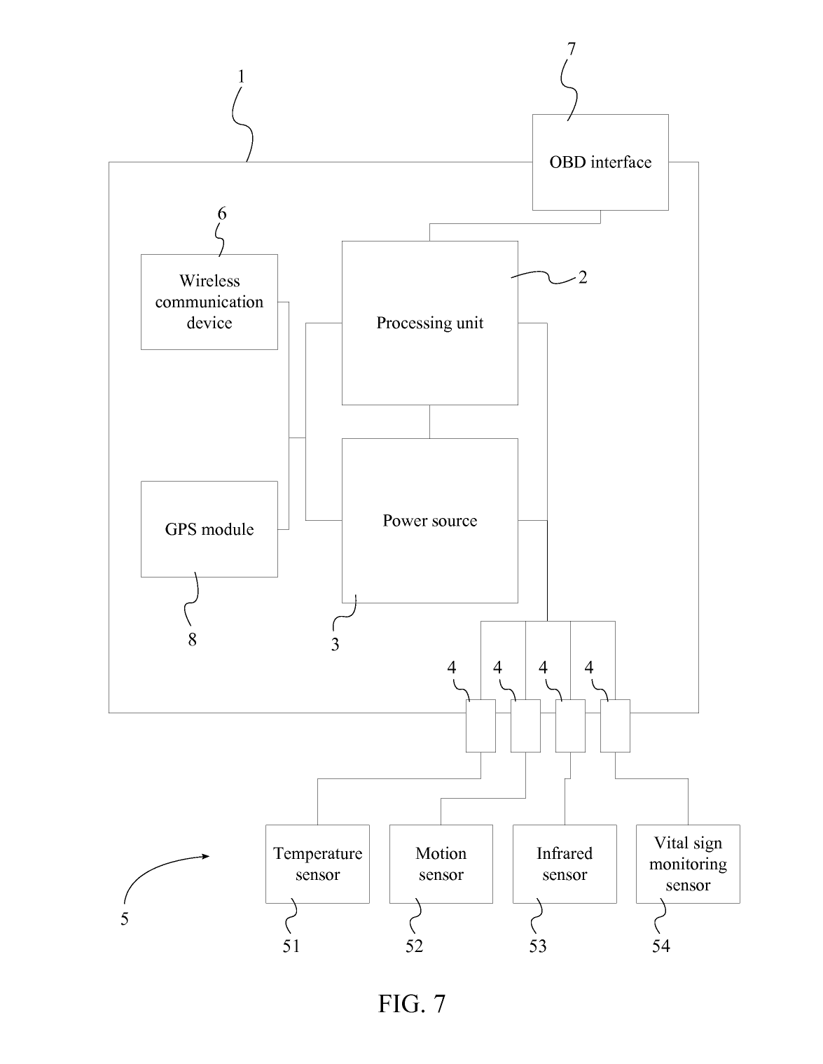

Referring to FIG. 7, in terms of physical components, the preferred apparatus of the present invention generally comprises a processing unit 2, a power source 3, at least one sensor 5, and a wireless communication device 6. In general, the aforementioned components may be integrated into the spatial environment in any useful manner which facilitates the use of the present invention. In the preferred physical embodiment for the vehicular application, the present invention is embodied as a standalone unit which can be interfaced with a vehicle's existing computer and control systems. To this end, an enclosure 1 is additionally comprised, as well as a plurality of sensor connection ports 4, and a vehicle on-board-diagnostic (OBD) interface 7. The wireless communication device 6 facilitates sending the driver notification and the emergency notification signal, and the OBD interface 7 facilitates utilizing the present invention by connecting the present invention to a vehicle's OBD port.

In the preferred embodiment, the processing unit 2, the power source 3, and the wireless communication device 6 are positioned within the enclosure 1. In an alternate embodiment, the power source 3 not may be integrated within the enclosure 1 in favor of an electrical connection for connecting an external power source 3, such as an extension cord or vehicle power source 3. The power source 3 is electrically connected to the processing unit 2, the plurality of sensor connection ports 4, the wireless communication device 6, and the OBD interface 7. The processing unit 2 is electronically connected to the plurality of sensor connection ports 4, the wireless communication device 6, and the OBD interface 7. The plurality of sensor connection ports 4 traverse through the enclosure 1 to allow any desired sensor to be utilized. The plurality of sensor connection ports 4 may alternatively be a hub external to the enclosure 1 attached via a wired connection, which traverses through the enclosure 1. Each of the at least one sensor 5 is preferably removably and electrically connected to one of the plurality of sensor connection ports 4, and thus to the processing unit 2 and the power source 3.

As previously discussed, the at least one sensor 5 may comprises any relevant sensor type for the desired application. However, in the preferred embodiment the at least one sensor 5 comprises a temperature sensor 51. The at least one sensor 5 preferably may also comprises one or more of the following in any combination or quantity: a motion sensor 52, an infrared sensor 53, a vital sign monitoring sensor 54, an air quality sensor, and a pressure sensor.

The preferred embodiment of the present invention additionally comprises a global positioning system (GPS) module, which is positioned within the enclosure 1, electrically connected to the power source 3, and electronically connected to the processing unit 2. The GPS module 8 enables the emergency response entity to acquire the location of the vehicle in order to respond to the emergency notification signal.

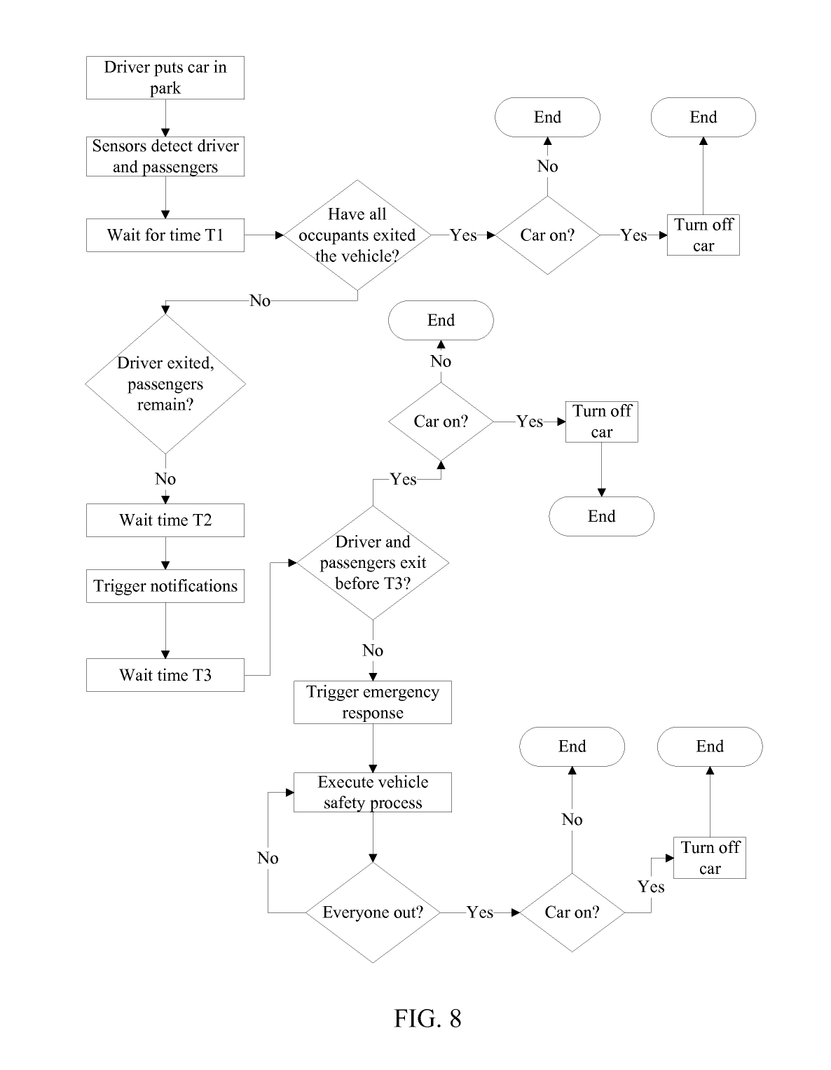

Referring to FIGS. 1 and 8, the following is an alternate description of the logical workflow of the preferred vehicular embodiment of the present invention. In the preferred embodiment of the present invention, the logical flow utilized follows a specific methodology. First, the user, who is also the driver, puts the car in park, as the system will work with the car turned on or off. The series of sensors detect the driver and any additional warm bodies in the vehicle. These warm bodies include, but are not limited to adults, children, and pets/animals. Sensed warm bodies are considered forms of input. The series of sensors then waits a predetermined time, T1 for the driver and additional warm bodies to exit the vehicle. The computerized system then asks itself a question and uses the sensed inputs to answer the question and make a decision. In this step as well as others, the answer will trigger a decision in the form of a response or an output. The response or outputs can be, but are not limited to physical, mechanical, or electrical actions, or simply moving on to the next step in the logical flow.

At this point in the logic, the question asked is as follows: “Have both the driver and additional warm bodies exited the vehicle before T1?” The next several steps in the logical flow depend on the answer to this. The answer is either ‘Yes’ or ‘No.’ If the answer is ‘Yes,’ the series of sensors will sense that there are no warm bodies left in the vehicle. Following this, the car will turn off if it is still on, the computer and series of sensors turns off, and the process ends. If the answer to the previous question is ‘No,’ however, the computer and series of sensors and possibly the car remain on, and the logical flow continues on to a different sequence.

If both the driver and additional warm bodies have not exited the vehicle before T1, the computerized system then asks: “Has the driver exited the vehicle before T1?” If the answer is ‘No,’ the series of sensors waits a predetermined time, T2 before triggering a response. In the preferred and other embodiments of this invention the response is but is not limited to a combination of audible, visual, and vibration notifications sent to the driver's mobile device (such as a text message or other notification), as well as several vehicle horn beeps. The horn will beep a predetermined number of times, n1. This occurs if the driver still has not exited the vehicle before T2 occurs.

After this occurs, the series of sensors then waits a predetermined time, T3 for the driver and additional warm bodies to exit the vehicle. The computer then asks its next question at time, T3 based on the sensed inputs: “Have the driver AND the additional warm bodies exited the vehicle at this point in time?” If the answer is ‘yes,’ the series of sensors will sense no warm bodies in the vehicle. With no warm bodies sensed, the car will turn off if still on, then the computer and series of sensors will turn off, and the process ends. If the answer is ‘No,’ an emergency response is activated. With this, the series of sensors trigger an emergency response call to a 3^{rd} party service safety team, such as Onstar or any emergency service team, calling for help. In order to locate the vehicle in distress, the 3^{rd} party service may use, but is not limited to using a GPS satellite tracking signal coming from the vehicle. At this point, the series of sensors will measure various inputs and actuate a specific vehicle safety process until all warm bodies have exited the vehicle. When the series of sensors no longer senses any warm bodies in the vehicle, the car will turn off if still on, then the computer and series of sensors turn off, and the process ends. This is the flow of logic if the driver has not exited the vehicle before time T1.

The process is similar for the case where the driver exits the vehicle before time T1. Returning to the beginning of the process, the car turns off and the sensors then detect the driver and additional warm bodies in the vehicle. Next, the sensors wait until time T1 for the driver and other warm bodies to exit the vehicle. If the driver and bodies have not exited by the time T1 occurs, the computer then asks itself if just the driver has exited the vehicle. In this case, the answer is ‘Yes,’ in which the driver has exited the vehicle, but not the other warm bodies.

Next, the series of sensors will detect the remaining warm bodies still in the vehicle. The series of sensors will then wait a predetermined time, T4 for the remaining warm bodies to exit the vehicle. At time, T4, the computer will ask itself: “Have all the additional warm bodies exited the vehicle at this point in time?” If the answer is ‘Yes,’ the series of sensors will not sense any warm bodies in the vehicle. With this input, the car will turn off if still on, then the computer and series of sensors will turn off, and the process ends. If the answer is ‘No,’ however, audible, visual, and vibration notifications will be sent to the driver's mobile device, and the vehicle horn will beep a predetermined number of times, n2.

The series of sensors will then wait a predetermined time, T5 for the additional warm bodies to exit the vehicle. At time, T5, the computer will ask itself: “Have all remaining bodies exited the vehicle at this point in time?” If the answer is ‘Yes,’ the series of sensors will sense no warm bodies in the vehicle. Thus, the car will turn off if still on, then the computer and series of sensors will turn off, and the process ends. If the answer is ‘No,’ the previously mentioned emergency response is activated. With this, the series of sensors triggers an emergency response call to a 3^{rd} party service safety team, requesting help. In order to locate the vehicle in distress, the 3^{rd} party service may use, but is not limited to using a GPS satellite tracking signal coming from the vehicle. At this point, the series of sensors will measure various inputs and actuate a specific vehicle safety process until all warm bodies have exited the vehicle. When the series of sensors no longer senses any warm bodies in the vehicle, the car turns off if still on, then the computer and series of sensors turns off, and the process ends. This ends the process completely until warm bodies enter the vehicle again at a different point in time.

In the preferred embodiment of the present invention, the framework is broken into three high-level steps. These steps are as follows: Are the sensors detecting warm bodies? If so, a mobile device and/or emergency response alert is triggered (step 2) followed by 3^{rd} party service notification (step 3). Step 1 activates based on the various inputs that include but are not limited to the temperature check, engine check, vital report, air check, water check, and nutrient check.

In the preferred embodiment of the present invention, the vehicle safety process includes, but is not limited to several functions: The sensors must take in several inputs when making decisions. These include but are not limited to, temperature inside and out of the vehicle at various points, the amount of sunlight entering the vehicle, the angle at which sunlight is entering, the number of warm bodies in the vehicle, the temperature of each warm body in the vehicle, oxygen levels, carbon monoxide levels, carbon dioxide levels, infrared levels, detected infrared motion, heart rate, humidity, whether or not seat belts are in use, which seat belts are in use, the weight distribution on each seat, whether or not the engine is turned on or off, and any other necessary inputs that measure the environment of the closed system.

In the preferred embodiment of the present invention, the vehicle safety process uses the various forms of input to actuate a proper response. These responses include but are not limited to, lowering/raising of windows, activation and regulation of air flow/fan speed, turning on or off the car's engine, activation and regulation of air conditioning, activation and regulation of heat, activation and regulation of entire climate control system, activation and regulation of seat warmers/coolers, and automatically unlocking doors. This safety process begins immediately after the series of sensors trigger the emergency response call to the 3^{rd} party safety team, and remains active in accordance to the logical flow explained above.

In the preferred embodiment of the present invention, the series of sensors sense the various inputs to elicit appropriate outputs. In the preferred embodiment the vehicle safety process outputs are activated in a different order depending on the situation (dictated by the inputs). Thus, the order in which the outputs are activated depends on the inputs. For example, if the car is still turned on at the beginning of the vehicle safety process, the windows may or may not rise or lower, the climate control system may or may not activate, the seat warmers may or may not activate, etc. These outputs all depend on the situation at hand, which varies depending on the sensed inputs. If it is warm inside the car, the vehicle system may lower the windows and turn on the climate control to activate the air conditioning. However, if the vehicle is low on gas, it may only lower the windows, or activate any necessary functions. Another example would be if a warm body is left in the car, while the car is turned on and inside a small garage. In this case, the safety process may choose to lower the windows, turn the car off, and then perform any other programmed functions to deal with the current situation. Depending on the user settings, notification details may be sent to the user's mobile device to alert him/her of each output response. These are only basic examples not intended to limit the scope of the invention. The order in which each response is activated is not intended to limit the scope of the invention.

Although the invention has been explained in relation to its preferred embodiment, it is to be understood that many other possible modifications and variations can be made without departing from the spirit and scope of the invention as hereinafter claimed.

1. A method of environmental occupant monitoring and hazard notification and mitigation by executing computer-executable instructions stored on a non-transitory computer-readable medium comprises the steps of:
providing a at least one sensor in a spatial environment;
detecting at least one environmental occupant in the spatial environment with the at least one sensor;
detecting a hazardous condition in the spatial environment with the at least one sensor; and
sending an emergency notification signal to an emergency response entity, if the environmental occupant is detected, and if the hazardous condition is detected.

2. A method of environmental occupant monitoring and hazard notification and mitigation by executing computer-executable instructions stored on a non-transitory computer-readable medium as claimed in claim 1 comprises the steps of:
providing an environmental control system, wherein the environmental control system controls attributes of the spatial environment; and
initiating a hazard mitigation protocol for the spatial environment through the environmental control system, if the environmental occupant is detected, and if the hazardous condition is detected, wherein the hazard mitigation protocol is executed through the environmental control system.

3. A method of environmental occupant monitoring and hazard notification and mitigation by executing computer-executable instructions stored on a non-transitory computer-readable medium as claimed in claim 1 comprises the steps of:
providing that the spatial environment is a vehicle;
providing that the at least one sensor comprises at least one occupant sensor;
continuously monitoring the spatial environment with the at least one occupant sensor in order to detect the at least one environmental occupant within the vehicle, wherein the at least one environmental occupant comprises a driver and at least one passenger; and
triggering a driver notification, if the driver is not detected by the at least one occupant sensor, and if the at least one passenger is detected by the at least one occupant sensor.

4. A method of environmental occupant monitoring and hazard notification and mitigation by executing computer-executable instructions stored on a non-transitory computer-readable medium as claimed in claim 3 comprises the steps of:
waiting for a first time interval;
waiting for a second time interval, if the driver is not detected by the occupant sensor, and if the at least one passenger is detected by the occupant sensor after the first time interval; and
triggering the driver notification after the second time interval, if the driver is not detected by the occupant sensor, and if the at least one passenger is detected by the occupant sensor after the second time interval.

5. A method of environmental occupant monitoring and hazard notification and mitigation by executing computer-executable instructions stored on a non-transitory computer-readable medium as claimed in claim 4 comprises the steps of:
waiting for a third time interval; and
sending the emergency notification signal to the emergency response entity, if the driver is not detected by the occupant sensor, and if the at least one passenger is detected by the occupant sensor after the third time interval.

6. A method of environmental occupant monitoring and hazard notification and mitigation by executing computer-executable instructions stored on a non-transitory computer-readable medium as claimed in claim 5 comprises the step of:
sending the emergency notification signal to the emergency response entity, if the driver is not detected by the occupant sensor, if the at least one passenger is detected by the occupant sensor after the third time interval, and if an acknowledgement message is not received from a mobile device, wherein the mobile device is associated with the driver.

7. A method of environmental occupant monitoring and hazard notification and mitigation by executing computer-executable instructions stored on a non-transitory computer-readable medium as claimed in claim 5 comprises the step of:
executing a vehicle safety protocol through an environmental control system of the vehicle, if the driver is not detected by the occupant sensor, and if the at least one passenger is detected by the occupant sensor after the third time interval.

8. A method of environmental occupant monitoring and hazard notification and mitigation by executing computer-executable instructions stored on a non-transitory computer-readable medium as claimed in claim 3 comprises the step of:
triggering the driver notification, if the at least one passenger is detected, and if the hazardous condition is detected.

9. A method of environmental occupant monitoring and hazard notification and mitigation by executing computer-executable instructions stored on a non-transitory computer-readable medium as claimed in claim 8 comprises the step of:
triggering the driver notification by sending an electronic message to a mobile device, wherein the mobile device is associated with the driver.

10. A method of environmental occupant monitoring and hazard notification and mitigation by executing computer-executable instructions stored on a non-transitory computer-readable medium as claimed in claim 3 comprises the step of:
sending the emergency notification signal to the emergency response entity, if the at least one passenger is detected, and if the hazardous condition is detected.

11. A method of environmental occupant monitoring and hazard notification and mitigation by executing computer-executable instructions stored on a non-transitory computer-readable medium as claimed in claim 3 comprises the steps of:
providing that the at least one sensor further comprises a temperature sensor; and
sending the emergency notification signal to the emergency response entity, if the at least one passenger is detected, and if a hazardous temperature is detected by the temperature sensor within the spatial environment.

12. A method of environmental occupant monitoring and hazard notification and mitigation by executing computer-executable instructions stored on a non-transitory computer-readable medium as claimed in claim 11 comprises the step of:
executing a vehicle safety protocol with the vehicle, if the at least one passenger is detected, and if the hazardous temperature is detected by the temperature sensor within the spatial environment.

13. A method of environmental occupant monitoring and hazard notification and mitigation by executing computer-executable instructions stored on a non-transitory computer-readable medium as claimed in claim 12 comprises the step of:
activating an air conditioning system of the vehicle as the vehicle safety protocol, if the at least one passenger is detected, and if the hazardous temperature is detected, wherein the air conditioning system is an environmental control system of the vehicle.

14. A method of environmental occupant monitoring and hazard notification and mitigation by executing computer-executable instructions stored on a non-transitory computer-readable medium as claimed in claim 12 comprises the step of:
opening at least one window of the vehicle through a window control system of the vehicle as the vehicle safety protocol, if the at least one passenger is detected, and if the hazardous temperature is detected, wherein the window control system is an environmental control system of the vehicle.

15. A device for environmental occupant monitoring and hazard notification and mitigation comprises:
an enclosure;
a processing unit;
a power source;
a plurality of sensor connection ports;
at least one sensor;
a wireless communication device;
the at least one sensor comprises a temperature sensor;
the processing unit, the power source, and the wireless communication device being positioned within the enclosure;
the plurality of sensor connection ports traversing through the enclosure;
the power source being electrically connected to the processing unit, the plurality of sensor connection ports, and the wireless communication device;
the processing unit being electronically connected to the plurality of sensor connection ports and the wireless communication device; and
each of the at least one sensor being removably and electrically connected to one of the plurality of sensor connection ports.

16. The device for environmental occupant monitoring and hazard notification and mitigation as claimed in claim 15 comprises:
the at least one sensor further comprises a motion sensor.

17. The device for environmental occupant monitoring and hazard notification and mitigation as claimed in claim 15 comprises:
the at least one sensor further comprises an infrared sensor.

18. The device for environmental occupant monitoring and hazard notification and mitigation as claimed in claim 15 comprises:
the at least one sensor further comprises at least one vital sign monitoring sensor.

19. The device for environmental occupant monitoring and hazard notification and mitigation as claimed in claim 15 comprises:
a vehicle on-board diagnostics (OBD) interface; and
the vehicle OBD interface being electronically connected to the processing unit.

20. The device for environmental occupant monitoring and hazard notification and mitigation as claimed in claim 15 comprises:
a global positioning system (GPS) module;
the GPS module being positioned within the enclosure;
the GPS module being electrically connected to the power source; and
the GPS module being electronically connected to the processing unit.
